(19) United States
(12) Patent Application Publication
(10) Pub. No.: US 2016/0361722 A1
(43) Pub. Date: Dec. 15, 2016

(54) Sorting and pulping device for kitchen waste

(71) Applicant: Bioland Environmental Technologies Group Corp. Ltd. (Beijing Branch), Beijing (CN)

(72) Inventors: Junying Shi, Beijing (CN); Chao Wang, Beijing (CN); Yichao Ping, Beijing (CN); Zejun Huang, Beijing (CN)

(73) Assignee: Bioland Environmental Technologies Group Corp. Ltd. (Beijing Branch)

(21) Appl. No.: 15/212,250

(22) Filed: Jul. 17, 2016

(30) Foreign Application Priority Data
Jul. 17, 2015 (CN) 201520523574.7

(51) Int. Cl. B02C 23/16; B02C 23/20; B02C 18/00

(52) U.S. Cl. CPC B02C 23/16; B02C 18/0084; B02C 23/20; B02C 2023/165

(57) ABSTRACT

A sorting and pulping device for kitchen waste includes a case (3). A screen cylinder is located within the case (3). A plurality of sieve pores are provided at a cylinder wall of the screen cylinder. A rotation shaft is located at an axle center of the screen cylinder, a bottom of the rotation shaft nears a bottom wall of the screen cylinder, and a top of the rotation shaft passes through a top of the screen cylinder and is linked with a driving device (5) located outside the case (3). Under an action of the driving device (5), the rotation shaft is driven to rotate. A plurality of blades, which are located with each other in parallel, are spirally distributed on the rotation shaft from top to bottom. Every blade inclines upwardly. A material feeding inlet (4) is located on a side wall of the case (3).

### CROSS REFERENCE OF RELATED APPLICATION

The present invention claims priority under 35 U.S.C. 119(a-d) to CN 201520523574.7, filed Jul. 17, 2015.

### BACKGROUND OF THE PRESENT INVENTION

### Field of Invention

The present invention relates to a technical field of kitchen waste treatment in environmental protection industry, and more particularly to a sorting and pulping device for kitchen waste.

### Description of Related Arts

Kitchen waste is one of the most important food waste, including edible residual (hogwash) produced by families, schools, canteens and catering industries, which is complex in component which a mixture of oil, water, peel, vegetable, rice flour, fish, meat, bones, tableware waste, plastics and paper towels. An amount of the kitchen waste is very huge in China, and increases rapidly.

The kitchen waste has high moisture content which accounts for 80%-90% of the total waste, high organic content, high grease, and high salt content. It is easy to perish, ferment, stink, and grow parasites, ovum, pathogenic microorganisms, enzyme toxin and harmful substances. However, compared with other waste, the kitchen waste has some advantages unable to be ignored as follows.

(1) The kitchen waste contains higher potential biological energy. if being effectively treated, the kitchen waste is able to achieve resource recycling and utilization, which is beneficial to reduce the energy consume.

(2) Compared with municipal waste, the kitchen waste has simple chemical composition, and less toxic and harmful substances. Therefore, if being treated well, the kitchen waste can become treasure.

Currently, the kitchen waste processing technologies at home and abroad comprise landfill, incineration, anaerobic digestion, aerobic composting, drying directly as feed, wet solution and microorganism treatment. More advanced foreign kitchen waste treatment technologies are mainly in European countries. South Korea and Japan kitchen waste treatment technologies are also more advanced, but the kitchen waste in China has large differences from foreign countries no matter the components and the sorting degrees. Foreign processing technologies and equipments are not suitable for the Kitchen waste treatment in China.

The kitchen waste in China has complex components which include plastic, paper, glass, wood, conch, ceramic, metal and bulky waste. To conveniently sort the waste for achieving the resource utilization of the waste, it is necessary to highly effectively separate organic matters from impurities such as plastics and metals. Relative equipments do not occur in prior arts.

### SUMMARY OF THE PRESENT INVENTION

Aiming at existing shortcomings of the prior arts, the present invention provides a sorting and pulping device for kitchen waste, which is capable of highly effectively separating organic matters from non-organic matters (including plastics and metals), and is beneficial to sort the waste, so that the resource utilization of the waste is achieved.

A technical scheme adopted by the present invention is as follows.

The present invention provides a sorting and pulping device for kitchen waste, which comprises a case, wherein: a screen cylinder is located within the case; a plurality of sieve pores are provided at a cylinder wall of the screen cylinder; a rotation shaft is located at an axle center of the screen cylinder, a bottom of the rotation shaft nears a bottom wall of the screen cylinder, and a top of the rotation shaft passes through a top of the screen cylinder and is linked with a driving device located outside the case; under an action of the driving device, the rotation shaft is driven to rotate; a plurality of blades, which are located with each other in parallel, are spirally distributed on the rotation shaft from top to bottom; every blade inclines upwardly.

A material feeding inlet is located on a side wall of the case; a slurry collecting tank, communicating with the screen cylinder, is located below the case; a slurry discharging pipe is connected with the slurry collecting tank; furthermore, an inlet of a slurry pump is communicated with the slurry collecting tank, an outlet thereof is communicated with the slurry discharging pipe; and a material discharging outlet, communicated with the screen cylinder, is located at a top of the case.

Preferably, an upwardly inclined angle of every blade is 5-12°.

Preferably, a pore size of every sieve pore is 10-30 mm.

Preferably, the driving device is a motor.

Preferably, a water inlet is located on the slurry collecting tank.

Preferably, an observing cleaning window is located on the case.

The sorting and pulping device for kitchen waste, provided by the present invention has advantages as follows.

(1) It is able to highly effectively separate the organic matters from the impurities such as plastics and metals, which is beneficial to sort the waste, thereby achieving resource utilization of the waste.

(2) It has simple structure and low cost, so that it is easy to be widely applied.

These and other objectives, features, and advantages of the present invention will become apparent from the following detailed description, the accompanying drawings, and the appended claims.

### BRIEF DESCRIPTION OF THE DRAWINGS

FIG. 1 is a structurally schematic view of a sorting and pulping device for kitchen waste according to a preferred embodiment of the present invention.

FIG. 2 is a sectional view of the sorting and pulping device for kitchen waste according to the preferred embodiment of the present invention.

### DETAILED DESCRIPTION OF THE PREFERRED EMBODIMENT

The present invention is further explained accompanying with drawings as follows.

A sorting and pulping device for kitchen waste, provided by the present invention, adopts the physical separation method, which is theoretically based on whether the organic matters and non-organic matters in the waste are able to be crushed under a high-speed impact, and after being crushed, the organic matters and non-organic matters have different abilities to be pulped. In general, most of the organic matters are able to be crushed under the high-speed impact, and then form the slurry by themselves or adding an appropriate amount of water, so that the slurry is discharged through a slurry discharging pipe. However, even if being partially crushed, the non-organic matters which are not easy to be crushed, such as plastics and metals, are still unable to form the slurry, so that the non-organic matters are only able to be discharged through a top material discharging outlet instead of a liquid discharging outlet. Therefore, the organic matters and the non-organic matters in the waste are able to be discharged through different material discharging outlets via the sorting and pulping device for kitchen waste, for separating the organic matters from the non-organic matters.

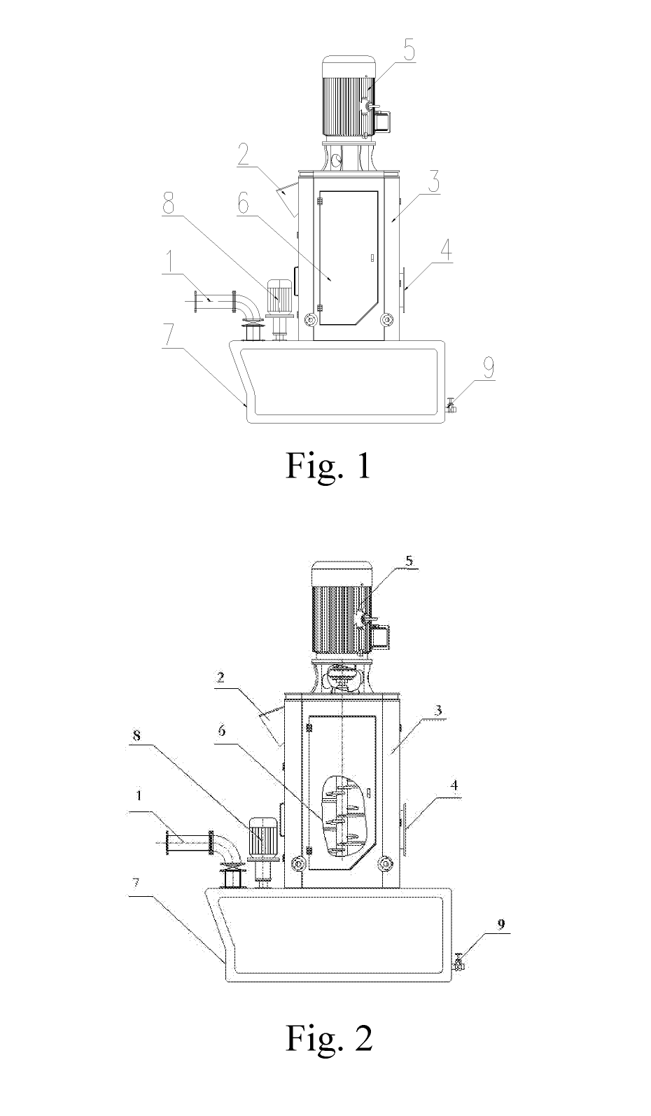

Specifically, referring to FIG. 1 and FIG. 2, a sorting and pulping device for kitchen waste is illustrated, which comprises a case 3, wherein a screen cylinder is located within the case 3; a plurality of sieve pores with a preferable pore size of 10-30 mm, are provided at a cylinder wall of the screen cylinder. A rotation shaft is located at an axle center of the screen cylinder, a bottom of the rotation shaft nears a bottom wall of the screen cylinder, and a top of the rotation shaft passes through a top of the screen cylinder and is linked with a driving device 5 located outside the case 3. The driving device 5 can be a motor. Under an action of the driving device 5, the rotation shaft is driven to rotate. A plurality of blades, which are located with each other in parallel, are spirally distributed on the rotation shaft from top to bottom. Every blade inclines upwardly with an inclination angle which can be adjusted according to practical technologies and characteristics of the kitchen waste to be treated, and generally, of 5-12°.

A material feeding inlet 4 is located on a side wall of the case 3. A slurry collecting tank 7, communicating with the screen cylinder, is located below the case 3. A slurry discharging pipe 1 is connected with the slurry collecting tank 7. Furthermore, an inlet of a slurry pump 8 is communicated with the slurry collecting tank 7, an outlet thereof is communicated with the slurry discharging pipe 1. A material discharging outlet 2, communicated with the screen cylinder, is located at a top of the case 3.

In addition, a water inlet 9 is located at the slurry collecting tank 7. An observing cleaning window 6 is located on the case 3. According to process water content needs, water is added to kitchen slurry through the water inlet 9, which is capable of simultaneously cleaning the device. When the device is blocked or other unforeseen circumstances occur, the observing cleaning window 6 is able to be opened for maintenance and cleaning.

The working principle of the above device is described as follows.

Kitchen waste entering the screen cylinder is separated by following processes. The screen cylinder, with a plurality of sieve pores at a circumstance thereof, is located within the closed case, the main shaft with a plurality of blades is located within the screen cylinder, and the blades are capable of simultaneously cutting and forming airflow. The objects to be treated within the screen cylinder are comprehensively cut by both the blades and the screen cylinder. The objects which are able to be cut, namely, the organic matters are pulped, and then flow into the slurry collecting tank through the sieve pores. The objects which are unable to be cut, such as plastics and metals, are discharged from the material discharging outlet at the top of the screen cylinder.

The above sorting and pulping device for kitchen waste has novel designs as follows.

(1) The screen cylinder with a plurality of sieve pores is located within the closed case, the rotation shaft with a plurality of blades is located within the screen cylinder, and the blades are capable of simultaneously cutting and forming airflow, thereby separating the organic matters from the non-organic matters.

(2) Through the liquid level switch, the interlocking control of the slurry pump and the material feeding device is capable of being achieved.

(3) The case has the function of cleaning the interior, which is achieved by connecting the water pipe with the water inlet.

The present invention also provides a method of sorting and pulping kitchen waste, which comprises steps of:

(1) starting a driving device 5, driving a rotation shaft located within a screen cylinder, and driving a plurality of blades fixed to the rotation shaft to rotate; and

(2) when the kitchen waste to be treated enters the screen cylinder through a material feeding inlet 4, the blades which rotate within the screen cylinder and a cylinder wall of the screen cylinder comprehensively cutting the kitchen waste, wherein after being cutting through the blades and the screen cylinder, organic matters in the kitchen waste are pulped, an obtained slurry flows into a slurry collecting tank 7 located below the screen cylinder through a plurality of sieve pores of the screen cylinder; and under a dual-function of hitting and airflow of the inclined blades, non-organic matters move upwardly along an inner wall of the screen cylinder to be discharged through a material discharging outlet 2, thereby achieving sorting and pulping the organic matters and non-organic matters in the kitchen waste.

Furthermore, the non-organic matters are unable to be cut by the blades and the sieve cylinder, and are divided into a first kind of non-organic matters and a second kind of non-organic matters, wherein the first kind of non-organic matters are matters whose density is larger than 1.0 g/cm³, and the second kind of non-organic matters are matters whose density is smaller than 1.0 g/cm³.

Under an action of continuous upward hit, the first kind of non-organic matters are discharged through the material discharging outlet 2 at the top of the sieve cylinder. Under an action of air flow produced by rotating the blades, the second kind of non-organic matters are discharged through the material discharging outlet 2 at the top of the sieve cylinder.

The method of sorting and pulping the kitchen waste further comprises a step of: a slurry pump 8 discharging the slurry which flows into the slurry collecting tank 7 to an exterior through a slurry discharging pipe 1.

The slurry of the kitchen waste has about 90% moisture content, complex components which comprise plastics, bones and metals. The sorting and pulping device for the kitchen waste, provided by the present invention, is particularly adapted for the kitchen waste and capable of highly effectively sorting and pulping the kitchen waste, and has a sorting efficiency of more than 95%, so that the organic matters are highly effectively separated from the non-organic matters (such as plastics and metals), and the obtained slurry is able to be directly fermented, so as to achieve resource utilization. Furthermore, the sorted non-organic matters (including plastics and metals) are able to be recycled. Therefore, the sorting and pulping device for the kitchen waste, provided by the present invention, is beneficial to sort and treat the waste, so as to achieve resource utilization.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sorting and pulping device for kitchen waste, comprising a case (3), wherein:
a screen cylinder is located within the case (3); a plurality of sieve pores are provided at a cylinder wall of the screen cylinder; a rotation shaft is located at an axle center of the screen cylinder, a bottom of the rotation shaft nears a bottom wall of the screen cylinder, and a top of the rotation shaft passes through a top of the screen cylinder and is linked with a driving device (5) located outside the case (3); under an action of the driving device (5), the rotation shaft is driven to rotate; a plurality of blades, which are located with each other in parallel, are spirally distributed on the rotation shaft from top to bottom, and every blade inclines upwardly;
a material feeding inlet (4) is located on a side wall of the case (3); a slurry collecting tank (7), communicating with the screen cylinder, is located below the case (3); a slurry discharging pipe (1) is connected with the slurry collecting tank (7); an inlet of a slurry pump (8) is communicated with the slurry collecting tank (7), and an outlet thereof is communicated with the slurry discharging pipe (1); and a material discharging outlet (2), communicated with the screen cylinder, is located at a top of the case (3).

2. The sorting and pulping device for kitchen waste, as recited in claim 1, wherein an upwardly inclined angle of every blade is 5-12°.

3. The sorting and pulping device for kitchen waste, as recited in claim 1, wherein a pore size of every sieve pore is 10-30 mm.

4. The sorting and pulping device for kitchen waste, as recited in claim 1, wherein the driving device (5) is a motor.

5. The sorting and pulping device for kitchen waste, as recited in claim 1, wherein a water inlet (9) is located on the slurry collecting tank (7).

6. The sorting and pulping device for kitchen waste, as recited in claim 1, wherein an observing cleaning window (6) is located on the case (3).
